(19) United States
(12) Patent Application Publication
(10) Pub. No.: US 2010/0060400 A1
(43) Pub. Date: Mar. 11, 2010

(54) Transformer and spiral flat winding thereof

(76) Inventors: Chun-Kong Chan, Hsin Chuang City (TW); Der-Ho Chi, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,116

(22) Filed: Sep. 11, 2008

(51) Int. Cl. H01F 27/30; H01F 41/00

(52) U.S. Cl. 336/185; 29/602.1

(57) ABSTRACT

A transformer includes a bobbin, an iron core and two spiral flat windings. The bobbin has a primary side portion, a secondary side portion and a separating plate. The separating plate is provided between the primary side portion and the secondary side portion. The first, second and third through holes are in communication with each other. The iron core penetrates the first, second and third through holes. The spiral flat winding is formed from a plurality of flat loops. The two spiral flat windings are provided on both sides of the separating plate and surround the primary side portion and the secondary side portion. Via the above arrangement, the spiral flat winding can be disposed around the bobbin, so that the assembling process can be performed simply and quickly. Thus, the working hours for assembling and the cost can be reduced.

### BACKGROUND OF THE INVENTION

1. Field of the Invention

The present invention relates to a transformer and the spiral flat winding thereof, and in particular to a transformer and the spiral flat winding thereof whereby a stepping-up, stepping-down or power-delivering process can be performed.

2. Description of Related Art

The transformer plays an important role in a power delivering system. The transformer can be used in power plants as well as in many electronic products available in the market. There are many types and ways of usage of transformers.

A transformer is constituted of at least two sets of adjacent windings, in which the magnetic fields generated by the windings intersect. Via the transformer, a stepping-up or stepping-down process can be performed. The stepping-up transformer increases the voltage and reduces the current, thereby yielding the power suitable for transport over long distances. The stepping-down transformer is used to yield power to be transmitted over short distances. The voltage can be lowered to a safe value, avoiding possible danger.

However, the windings of the conventional transformer are primarily made of wires that are wound around a bobbin to surround an iron core tightly, thereby generating a desired intersecting of magnetic fields. Although the wire is wound around the bobbin, the gap between each winding must be kept tight otherwise the desired electromagnetic effect cannot be achieved. Therefore, the conventional windings waste a lot of working time. This drawback directly increases the manufacturing costs, and thus reduces the profit.

Consequently, because of the above limitation resulting from the technical design of prior art, the inventor strives via real world experience and academic research to develop the present invention, which can effectively improve the limitations described above.

### SUMMARY OF THE INVENTION

The object of the present invention is to provide a transformer and its spiral flat winding. The assembling process can be performed simply and quickly. After the assembling process is completed, the respective coils of the winding are arranged tightly and orderly, thereby reducing the time for assembling and the cost. In this way, the product yield can be increased.

In order to achieve the above objects, the present invention provides a spiral flat winding provided on a bobbin of a transformer and surrounding an iron core, which is characterized in that the spiral flat winding is formed from a plurality of flat loops.

In order to achieve the above objects, the present invention further provides a transformer, which includes a bobbin having a primary side portion, a secondary side portion and a separating plate, the primary side portion having a first through hole, the secondary side portion having a second through hole, the separating plate having a third through hole, the separating plate being provided between the primary side portion and the secondary side portion, the first, second and third through holes being in communication with each other; an iron core penetrating the first, second and third through holes; and two spiral flat windings being formed from a plurality of flat loops, the two spiral flat windings being provided on both sides of the separating plate and surrounding the primary side portion and the secondary side portion respectively.

In order to achieve the above objects, the present invention further provides a method for assembling a transformer, which includes the steps of: providing a bobbin, the bobbin comprising a primary side portion, a secondary side portion and a separating plate, the primary side portion, the secondary side portion and the separating plate having a first through hole, a second through hole and a third through hole respectively; providing two spiral flat windings each being formed from a plurality of flat loops; connecting the two spiral flat windings to one end of the primary side portion and the secondary side portion respectively; connecting one end of the primary side portion and the secondary side portion to both sides of the separating plate respectively with the first, second and third through holes being in communication with each other, both sides of the separating plate abutting one end of the two spiral flat windings respectively, so that the flat loops are arranged tightly; and providing an iron core, the iron core penetrating the first, second and third through holes.

The present invention has advantageous features as follows. Since the spiral flat winding can surround the bobbin directly, the assembling process thereof can be performed simply and quickly. After the assembling process is completed, the respective coils are arranged tightly and orderly. Thus, the working hours for assembling and the cost can be reduced. As a result, the yield and profit of the products can be increased.

In order to further understand the characteristics and technical contents of the present invention, a detailed description relating thereto will be made with reference to the accompanying drawings. However, the drawings are illustrative only, but not used to limit the scope of the present invention.

### BRIEF DESCRIPTION OF THE DRAWINGS

FIG. 1 is a perspective view showing the spiral flat winding according to the first embodiment of the present invention;

FIG. 2 is a side view showing the spiral flat winding according to the first embodiment of the present invention;

FIG. 3 is an end view showing the spiral flat winding according to the first embodiment of the present invention;

FIG. 4 is a perspective view showing the spiral flat winding according to the second embodiment of the present invention;

FIG. 5 is a side view showing the spiral flat winding according to the second embodiment of the present invention;

FIG. 6 is an end view showing the spiral flat winding according to the second embodiment of the present invention;

FIG. 7 is an exploded view showing the transformer of the present invention;

FIG. 8 is an assembled view showing a portion of the transformer of the present invention; and

FIG. 9 is an assembled view showing the whole transformer of the present invention.

### DETAILED DESCRIPTION OF PREFERRED EMBODIMENTS

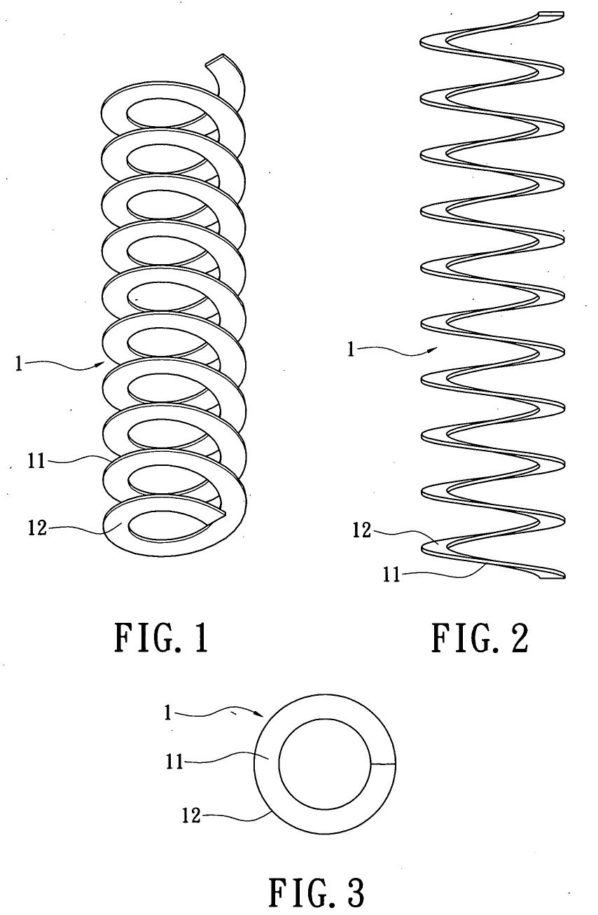

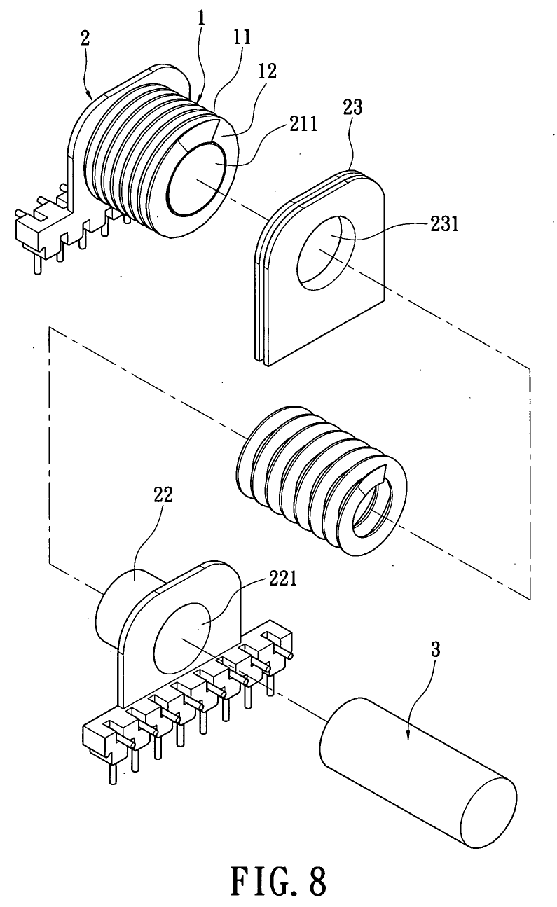

Please refer to FIGS. 1 to 3, which show the spiral flat winding 1 according to the first embodiment of the present invention. The spiral flat winding 1 is integrally formed from a copper sheet and has the shape of a spring, compressed such that its windings are close to each other (FIG. 8).

The surface of the spiral flat winding 1 has a cladding layer 12. The cladding layer 12 is made of an insulating material (such as an insulating paint) that can be coated on the surface of the spiral flat winding 1, thereby achieving a desired insulating effect.

In the present embodiment, each of the flat loops 11 is a circular flat sheet, and they are spirally formed into the flat winding.

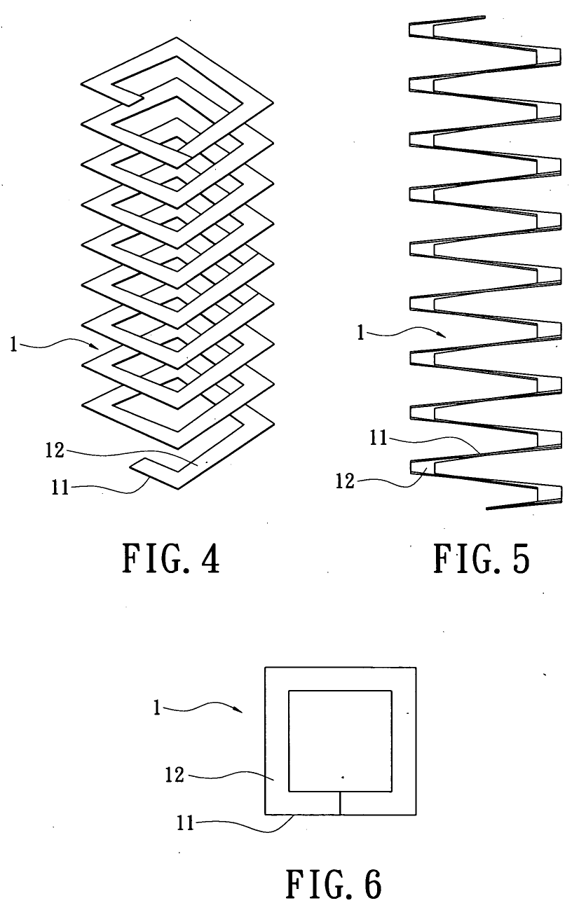

Please refer to FIGS. 4 to 6, which show the spiral flat winding 1 of the second embodiment of the present invention. Each of the flat loops 11 can be a rectangular flat sheet. Like the first embodiment, the flat loops 11 of the present embodiment can be connected to each other to form a square spiral shape.

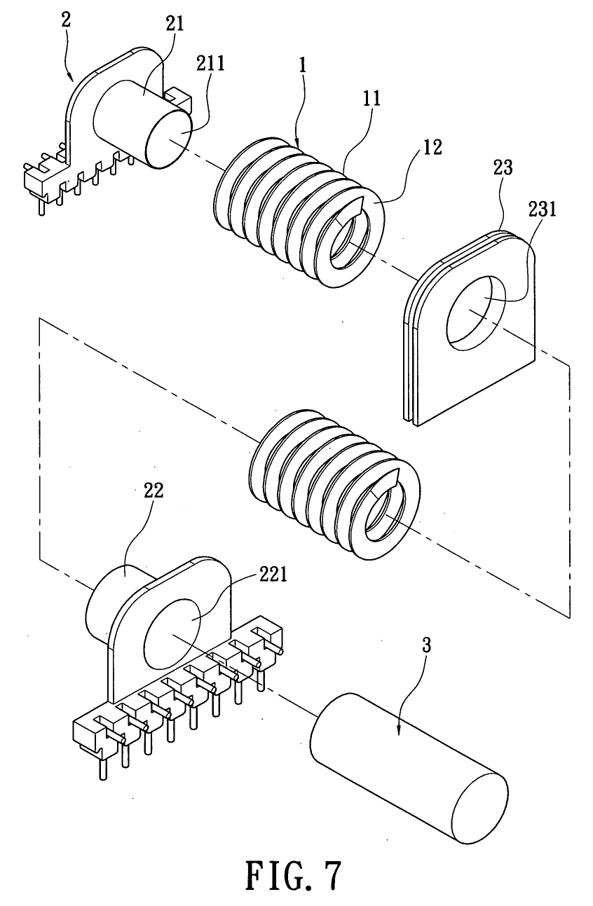

The flat loops 11 of the spiral flat winding 1 of the present invention are not limited to the above circular or rectangular shapes as long as the flat loops 11 acting as a basic unit can be spirally formed into the spiral flat winding 1 that can disposed around the bobbin 2 (FIG. 7), which can be viewed as the equivalent modifications of the present invention.

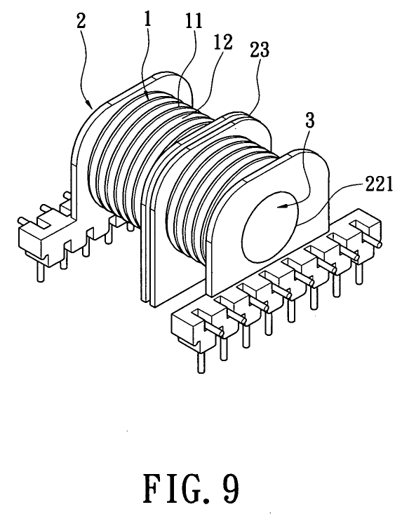

Please refer to FIGS. 7 to 9, which show the transformer of the present invention, which includes two spiral flat windings 1, a bobbin 2 and an iron core 3.

The bobbin 2 comprises a primary side portion 21, a secondary side portion 22 and a separating plate 23.

The primary side portion 21 and the secondary side portion 22 are cylindrical structures opposite to each other. The primary side portion 21 and the secondary side portion 22 have a first through hole 211 and a second through hole 221 respectively. The separating plate 23 is a plate-like structure, which can be disposed between the primary side portion 21 and the secondary side portion 22 to separate them from each other. The separating plate 23 has a third through hole 231. The third through hole 231 passes through both sides of the separating plate 23 and is positioned corresponding to the first through hole 211 and the second through hole 221.

The iron core 3 is a cylindrical structure corresponding to the first through hole 211, the second through hole 221 and the third through hole 231. The iron core 3 penetrates the first through hole 21, the second through hole 221 and the third through hole 231.

The two spiral flat windings 1 can be disposed on both sides of the separating plate 23 and put on the primary side portion 21 and the secondary side portion 22, thereby surrounding the iron core 3 to generate a desired electromagnetic effect.

The assembling steps can be performed in the following order. First, a bobbin 2 and two spiral flat windings 1 are provided. The two spiral flat windings 1 are connected to one end of the primary side portion 21 and the secondary side portion 22 respectively.

Then, the primary side portion 21 and the secondary side portion 22 are connected to both sides of the separating plate 23 respectively, so that the first through hole 211, the second through hole 221 and the third through hole 231 can be brought into communication with each other. At this time, both sides of the separating plate 23 will abut both ends of the two spiral flat windings 1, so that the flat loops 11 are arranged to abut each other tightly.

Finally, the iron core 3 penetrates the first through hole 211, the second through hole 221 and the third through hole 231. The two spiral flat windings 1 have been disposed around the iron core, thereby generating a desired electro-magnetic effect.

Via the above steps, a transformer can be assembled completely and the stepping-up and stepping-down process can be performed.

The present invention can achieve advantageous features as follows.

The spiral flat winding 1 can be disposed around the bobbin 2 directly, so that the assembling process can be performed simply and quickly. After the assembling process is completed, the respective flat loops 11 are arranged tightly. The working hours for assembling and thus the cost can be reduced. Therefore, the yield and profit of the products can be increased.

While the present invention has been described in terms of what is presently considered to be the most practical and preferred embodiments, it is to be understood that the present invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A spiral flat winding provided on a bobbin of a transformer and surrounding an iron core, characterized in that: the spiral flat winding is formed from a plurality of flat loops.

2. The spiral flat winding according to claim 1, wherein the surface of the spiral flat winding has a cladding layer.

3. The spiral flat winding according to claim 2, wherein the spiral flat winding is made of copper sheet.

4. The spiral flat winding according to claim 3, wherein the flat loops are arranged to abut each other tightly.

5. The spiral flat winding according to claim 3, wherein each of the flat loops of the spiral flat winding is a rectangular flat sheet.

6. The spiral flat winding according to claim 3, wherein each of the flat loops of the spiral flat winding is a circular flat sheet.

7. A transformer, comprising:
a bobbin having a primary side portion, a secondary side portion and a separating plate, the primary side portion having a first through hole, the secondary side portion having a second through hole, the separating plate having a third through hole, the separating plate being provided between the primary side portion, and the secondary side portion, the first, the second and third through holes being in communication with each other;
an iron core penetrating the first, second and third through holes; and
two spiral flat windings being formed from a plurality of flat loops, the two spiral flat windings being provided on both sides of the separating plate and surrounding the primary side portion and the secondary side portion respectively.

8. The transformer according to claim 7, wherein the surface of the spiral flat winding has a cladding layer.

9. The transformer according to claim 8, wherein the spiral flat winding is made of copper sheet.

10. The transformer according to claim 9, wherein the flat loops are arranged to abut each other tightly.

11. The transformer according to claim 9, wherein each of the flat loops of the spiral flat winding is a rectangular flat sheet.

12. The transformer according to claim 9, wherein each of the flat loops of the spiral flat winding is a circular flat sheet.

13. A method for assembling a transformer, comprising the steps of:
providing a bobbin, the bobbin comprising a primary side portion, a secondary side portion and a separating plate, the primary side portion, the secondary side portion and the separating plate having a first through hole, a second through hole and a third through hole respectively;
providing two spiral flat windings each being formed from a plurality of flat loops;
connecting the two spiral flat windings to one end of the primary side portion and the secondary side portion respectively;
connecting one end of the primary side portion and the secondary side portion to both sides of the separating plate respectively with the first, second and third through holes being in communication with each other, both sides of the separating plate abutting one end of the two spiral flat windings respectively, so that the flat loops are arranged tightly; and
providing an iron core, the iron core penetrating the first, second and third through holes.

14. The method according to claim 13, wherein the spiral flat winding is made of copper sheet.

15. The method according to claim 14, wherein the spiral flat winding is formed via a cold rolling process.

16. The method according to claim 15, wherein the surface of the spiral flat winding has a cladding layer.

17. The method according to claim 16, wherein the flat loops are arranged to abut each other tightly.
